(19) United States
(12) Patent Application Publication
(10) Pub. No.: US 2023/0226455 A1
(43) Pub. Date: Jul. 20, 2023

(54) GRIP FOR GAME CONSOLE

(71) Applicant: SATISFYE, INC., Charlotte, NC (US)

(72) Inventor: Phillip Brand, Charlotte (NC)

(21) Appl. No.: 17/992,725

(22) Filed: Nov. 22, 2022

Related U.S. Application Data
(60) Provisional application No. 63/300,436, filed on Jan. 18, 2022.

(51) Int. Cl. A63F 13/98; A63F 13/92

(52) U.S. Cl. CPC A63F 13/98; A63F 13/92

(57) ABSTRACT

An ergonomic grip for a portable game console comprising a central body portion with a left handgrip and a right handgrip connected to the left and right sides of the central body portion. A central recessed area is formed between the left handgrip and the right handgrip. Cushioning tabs are positioned at one or more interior surfaces of the ergonomic grip facing the central recessed area. The tabs are compressible to both cushion a portable game console positioned in the central recessed area and retain the portable game console via friction fit. The cushioning tabs are adapted to be compressed between the portable game console and the corresponding interior surfaces. The degree of compression of the tabs is variable with the size of the portable game console so that portable game consoles of different sizes will be securely held within the central recessed area.

### RELATED APPLICATIONS

This application claims priority under 35 U.S.C. § 119(e) to U.S. Provisional Application No. 63/300,436, entitled “GRIP FOR GAME CONSOLE”, filed Jan. 18, 2022, which is fully incorporated herein by reference for all purposes.

### TECHNICAL FIELD

The invention relates to portable game console accessories, and more particularly to improved ergonomic grips that can be used with portable game consoles.

### BACKGROUND

Video games have become increasingly popular among both youths and adults. A number of companies have developed portable/handheld video game consoles that are available with a variety of features and form factors. Most of these systems have handheld/built in consoles that are provided to enable users to play video games without being tethered to televisions or monitors.

While handheld game consoles provide the features necessary to allow users to play video games, not all of these integrated consoles are designed with the best ergonomics. The consoles may therefore cause some discomfort for users, particularly when used for a prolonged period of time. For example, the flat contours of a handheld console typically do not conform to the rounded contours of a user's hands, so the user may not be able to securely grip the console. The console may also be designed with buttons or thumbsticks that are positioned in a way that requires the user to maintain their hands in an awkward or uncomfortable position. When the integrated console is used for a prolonged period of time, minor ergonomic issues such as these may become significant problems. They may even cause painful stresses in the user's hands.

Various accessories have therefore been developed to improve the ergonomics of portable game consoles. One such accessory is a grip that can be used to hold the portable game console. The grip may, for example, provide handgrips which conform to the contours of the user's hands and may therefore make it easier for the user to maintain a secure and comfortable grip on the game console. The handgrips may also modify the positions of the user's hands when using the console to achieve a more natural position which is more comfortable and may reduce the stress on the user's hands when using the console.

While currently available grips for handheld game consoles may improve the ergonomics of using these consoles, they still have various drawbacks. For instance, it is typical for ergonomic grips to be slid onto the handheld game consoles, where the fit between the grip and the console is tight enough that the grip can hold in place. The grips, however, are commonly made of a hard plastic which can scratch a console when the grip is installed on the console. Obviously, this damage is undesirable.

It is also common for a grip to have a central piece which, when the grip is installed on the handheld console installed, is positioned against the back of the console. This central piece of the grip can inhibit airflow around the console so that the heat from the console is not properly dissipated. This causes additional heating in the console, which can result in expansion of the console battery, or bowing of the console housing. Again, this causes undesirable damage to the console.

Another problem with existing ergonomic grips for handheld consoles is that some consoles are available in different versions which may have slightly different sizes. Because the existing ergonomic grips are typically constructed with relatively tight tolerances in order to securely hold the console, small changes in the dimensions of the console from one version to another may create significant problems in relation to the ability of a single ergonomic grip to securely hold two different versions of a console which have different sizes. if the ergonomic grip cannot securely hold the console, though console may fall out of the grip during use, causing significant damage to the console.

### SUMMARY

Embodiments disclosed herein can reduce or eliminate the problems discussed above by providing an ergonomic grip for a handheld console, where the grip includes flexible elements that serve to accommodate size differences between different versions of the console so that multiple sizes can be securely held in place by the ergonomic grip, as well as to float the console above the hard plastic surfaces of the grip, thereby preventing these hard surfaces from scratching the console and also increasing air circulation around the console to prevent damage from heating in the console.

In one embodiment, the ergonomic grip has a central back support which is an elongated flat portion which is positioned behind the console. Ergonomic handgrips are provided at each of the left and right ends of the central back support, and retaining arms extend downward from the bottom of the central back support. The central back support, handgrips and retaining arms define a central recessed area within which the console is positioned. The handgrips and retaining arms have inward facing surfaces which are adjacent to the console/central recessed area. The inward facing surfaces wrap slightly around the front of the console/central recessed area in order to secure the console in the recessed area. Flexible tabs are provided on the central back portion, as well as the inward facing surfaces of the handgrips (and in some cases the retaining arms) in order to prevent direct contact between the hard surfaces of the ergonomic grip and the console. The flexible tabs also allow consoles of slightly varying sizes to fit snugly and securely within the central recessed area.

One embodiment comprises an ergonomic grip for a portable game console comprising a central body portion with a left handgrip and a right handgrip connected to the left and right sides of the central body portion, where a central recessed area formed between the left handgrip and the right handgrip. A set of cushioning tabs is positioned at one or more interior surfaces of the ergonomic grip, where the tabs are positioned between the corresponding interior surfaces and the central recessed area. The ergonomic grip is adapted to securely hold a portable game console in the central recessed area. The cushioning tabs are adapted to contact the portable game console and to be compressed between the portable game console and the corresponding interior surfaces, where friction between the cushioning tabs and the portable game console retains the portable game console in the central recessed area. The cushioning tabs may be made of a flexible material that is adapted to be compressible to a lesser degree to hold a portable game console of a first, smaller size, and they are compressible to a second, greater degree to hold a portable game console of a second, larger size. The ergonomic grip can therefore be used with portable game consoles of different sizes without the ergonomic grip having to be modified or adjusted in any way.

In some embodiments, the cushioning tabs include a set of side tabs that are positioned at the interior surfaces of each handgrip with the tabs between the corresponding interior surface and the central recessed area. A set of the cushioning tabs may comprise a single unit in which the tabs are formed integrally with a connecting member, which may facilitate both the manufacture of the tabs themselves and the assembly of the tabs into the ergonomic grip. The central body portion, and/or the handgrips may comprise a shell that includes corresponding ones of the interior surfaces, where the shell has a set of holes through the interior surface(s), and where the single unit having the cushioning tabs is positioned with the tabs extending through the holes while the connecting member of the unit is secured within the shell.

In some embodiments, the central body portion of the ergonomic grip comprises a back plate which has a substantially planar interior surface facing the central recessed area. The left edge of the back plate is connected to the back edge of the left handgrip and the right edge of the back plate is connected to the back edge of the right handgrip. Each of the left and right handgrips has a corresponding interior surface facing the central recessed area. Each handgrip interior surface has a corresponding front edge that wraps around the front of the corresponding side of the central recessed area and extends inward toward the central recessed area.

The side tabs positioned at the interior surfaces the handgrips are positioned between the corresponding interior surface and the central recessed area. The set of side tabs on each handgrip may include one or more front tabs which are adjacent to the front edges of the handgrip interior surfaces, where the front edges of the handgrip interior surfaces provide support to the front tabs which are adapted to contact the front edge of a portable game console positioned in the central recessed area. The set of side tabs may also include one or more back side tabs adjacent to the back edges of the handgrip interior surfaces, where the back side tabs are adapted to contact the back edge of a portable game console positioned in the central recessed area. The ergonomic grip may also have a set of back tabs located on the interior surface of the back plate, where the set of back tabs are adapted to contact the back of a portable game console positioned in the central recessed area and to maintain a space between the portable game console and the interior surface of the back plate, allowing air to circulate between the back plate and the portable game console.

In some embodiments, the ergonomic grip may include one or more retaining arms which are connected to the central body portion and which extend downward from the central body portion. The retaining arms have corresponding interior surfaces that face the central recessed area for supporting a portable game console in the central recessed area. Some embodiments include the portable game console which is positioned in the central recessed area.

One alternative embodiment comprises a method in which a shell of an ergonomic grip is provided. The shell has two or more pieces and includes a central body portion, a left handgrip connected to a left side of the central body portion and a right handgrip connected to a right side of the central body portion. The shell has one or more interior surfaces which, upon assembly of the shell, face a central recessed area of the ergonomic grip. The shell has one or more sets of holes through at least one of the interior surfaces. The method further includes providing one or more tab units, each of the tab units having cushioning tabs extending from a connecting member. Each tab unit is positioned so that the corresponding cushioning tabs extend through a corresponding set of holes in at least one interior surface of the shell. The pieces of the shell are then secured to each other to form the ergonomic grip, where the securing of the shell pieces to each other secures each tab unit in position with the tabs extending through the holes. In some embodiments, the tabs are positioned at interior surfaces of the left handgrip and right handgrip. The method may also include positioning a portable game console in the central recessed area of the ergonomic grip, where the portable game console is secured in the central recessed area by contact between left and right edges of the portable game console and the tabs positioned at interior surfaces of the left handgrip and right handgrip.

Another alternative embodiment comprises a method which includes providing an ergonomic grip having a central body portion and a left and right handgrips connected to the left and right sides of the central body portion. A central recessed area is formed between the left handgrip and the right handgrip, and a set of cushioning tabs positioned at one or more interior surfaces of the ergonomic grip, where the tabs are positioned between the corresponding interior surfaces and the central recessed area. The method further includes positioning a first portable game console in the central recessed area, where the first portable game console compresses the cushioning tabs and where friction between the cushioning tabs and the first portable game console retains the first portable game console in the central recessed area. The method may also include removing the first portable game console from the central recessed area of the ergonomic grip and positioning a second portable game console in the central recessed area, where the second portable game console is larger in at least one dimension than the first portable game console. Since the second portable game console is larger, it compresses the cushioning tabs to a greater degree than the first portable game console. For both sizes of portable game consoles, friction between the cushioning tabs and the portable game console retains the portable game console in the central recessed area. The method may also include removing the larger portable game console from the central recessed area of the ergonomic grip and replacing it with the smaller portable game console. When switching from one size portable game console to the other, no adjustment or modification of the ergonomic grip is necessary, since the tabs are compressible to different degrees to accommodate the different sizes of the portable game consoles while maintaining sufficient contact and friction with the portable game consoles to retain them in the central recessed area.

Numerous alternative embodiments may also be possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIGS. 1A and 1B are diagrams illustrating an example ergonomic grip in accordance with one embodiment secured to a handheld console.

FIGS. 2A and 2B are diagrams illustrating an example ergonomic grip in accordance with one embodiment.

FIGS. 3A and 3B are diagrams illustrating the structure of flexible back tabs and side tabs of an ergonomic grip in accordance with one embodiment.

FIG. 4 is a diagram illustrating the structure of back tab and side tab assemblies in accordance with some embodiments

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

One exemplary embodiment comprises an ergonomic grip for a portable game console comprising a central body portion with a left handgrip and a right handgrip connected to the left and right sides of the central body portion. A central recessed area is formed between the left handgrip and the right handgrip. Cushioning tabs are positioned at one or more interior surfaces of the ergonomic grip facing the central recessed area. The tabs are compressible to both cushion a portable game console positioned in the central recessed area and retain the portable game console (via friction between the tabs and the portable game console). The cushioning tabs are adapted to be compressed between the portable game console and the corresponding interior surfaces. The degree of compression of the tabs is variable, depending upon the size of the portable game console—a smaller portable game console will compress the tabs to a lesser degree, while a larger portable game console will compress the tabs to a greater degree. In both cases, the tabs maintain their cushioning and friction-fit characteristics to securely hold the different sized portable game consoles.

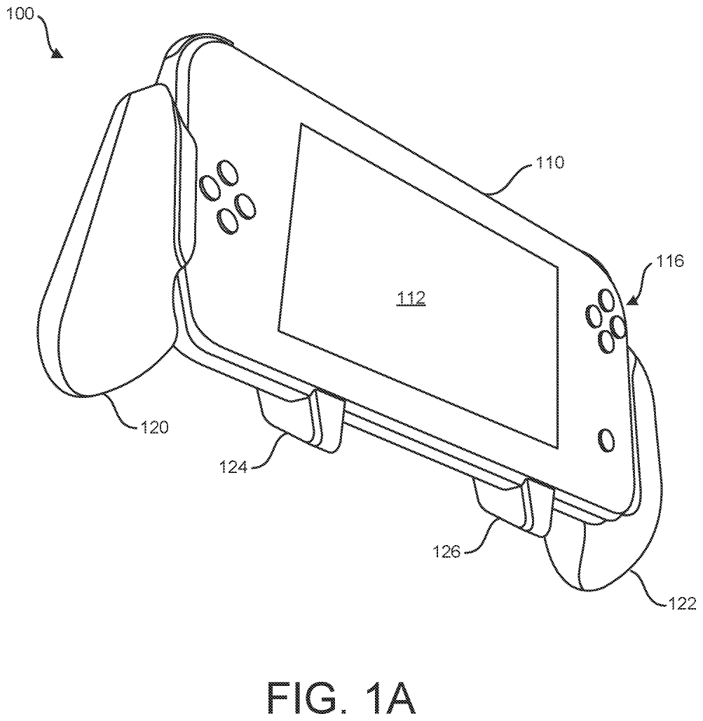

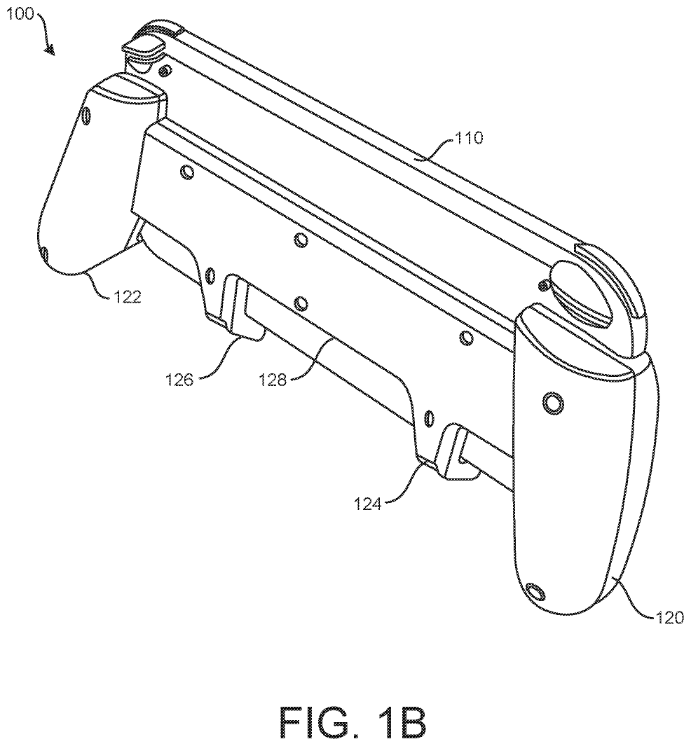

An example embodiment is shown in FIGS. 1-4 and described in the accompanying text below.

Referring to FIGS. 1A and 1B, an example ergonomic grip 100 is shown installed on a handheld console 110. FIG. 1A is a perspective view of the console and ergonomic grip from the front these devices, while FIG. 1B is a perspective view of the console and grip from the back of the devices.

Console 110 is generally flat/rectangular in shape, with a central display 112 at the center of the face of the console. A first set of controls open (e.g., buttons) 114 are positioned to the left of screen 112, and a second set of controls (e.g., buttons and a thumbstick) 116 are positioned to the right of screen 112.

Console 110 is positioned within a recessed area of ergonomic grip 100 between a left handgrip 120 and a right handgrip 122. A pair of lower retaining arms 124 and 126 are positioned to contact the lower edge of console 110 when the console is inserted into the recessed area, and thereby effectively define the edge of the recessed area. the upper end of the recessed area is open so that console 110 can be slid into the recessed area from the top of ergonomic grip 110. A central back support 128 is formed as a plate which is connected at its left and right edges between left and right handgrips 120 and 122. Lower retaining arms 124 and 126 extend downward from the central back support.

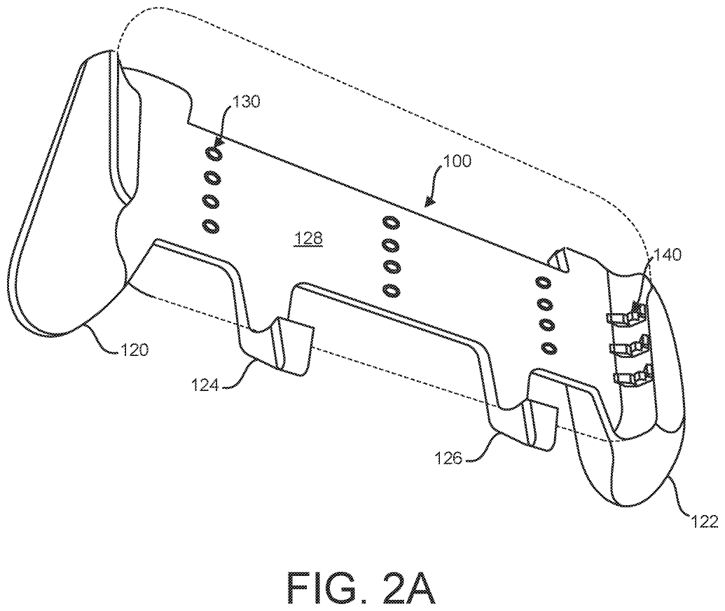

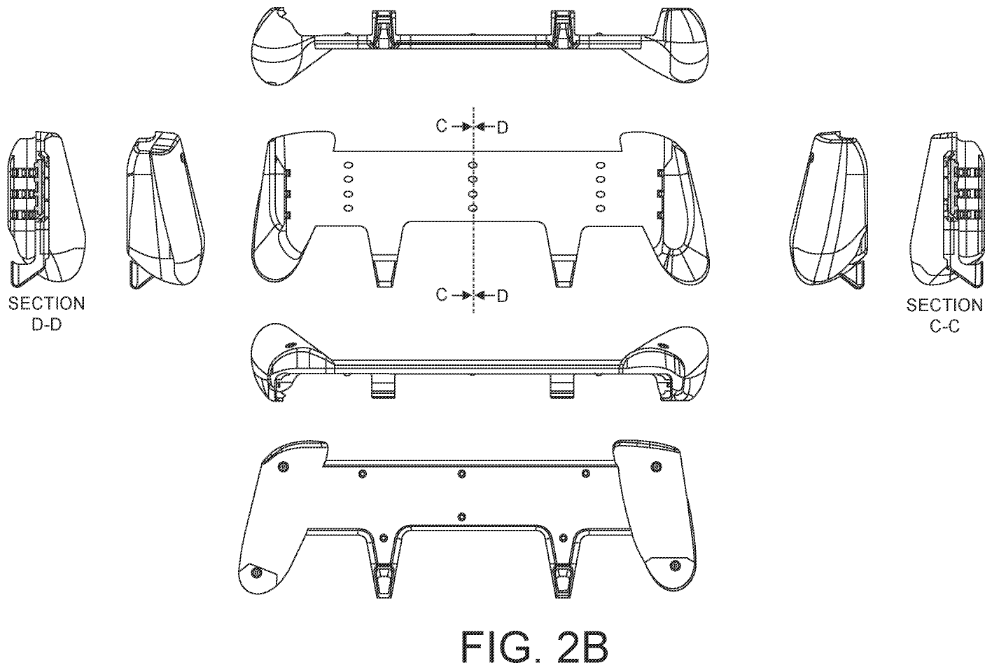

Referring to FIG. 2A, a perspective view of ergonomic grip 100 is shown without console 110 installed in the central recessed area. FIG. 2B shows plan views of ergonomic grip 100, including bottom, front, top, back and side views of the grip.

In FIG. 2A, it can be seen that a set of tabs or spacers 130 are provided on central back support 128. Since tabs 130 are positioned on central back support 128 to support the back of console 110, these tabs may be referred to herein as back tabs or back spacers.

In this particular embodiment, there are three rows of four tabs each. Each of tabs 130 extends upward from the substantially planar surface of central back support 128. When console 110 is installed in the central recessed area, the back of console 110 contacts tabs 130 instead of central back support 128. This maintains a small amount of space between central back support 128 and the back of console 110 so that air can circulate between the central back support and the console. This improves heat dissipation from the console and helps to prevent it from overheating. Excessive heat in this area can cause bowing of the console body and can also reduce the lifespan of the console. It should be noted that back tabs 130 also serve to cushion the console within the central recessed area of ergonomic grip 100 and to help prevent the console from slipping out of the central recessed area.

In this embodiment, the body of ergonomic grip 100 is made of a substantially rigid material such as polycarbonate plastic, which can maintain the overall shape of the grip. tabs 130 are made of a flexible elastomeric material so that they do not scratch console 110 when the console is installed in ergonomic grip 100. Although not shown in the figure, similar tabs/spacers may be provided on the surfaces of retaining arms 124 and 126 which face the console in order to prevent these surfaces from scratching the console.

It can be seen in FIG. 2A that several tabs or spacers are also positioned on the interior surface of handgrip 122 (i.e., the surface that faces the central recessed area of the ergonomic grip). A similar set of tabs 140 is positioned on the interior surface of handgrip 120, but these tabs are not visible in this figure behind the outer surface of the handgrip. The interior surface of the handgrip may be considered “concave” in the it wraps around the edge of the portable game console positioned in the central recessed area. It should be noted that “concave,” as used herein, does not imply that the interior surface is round.

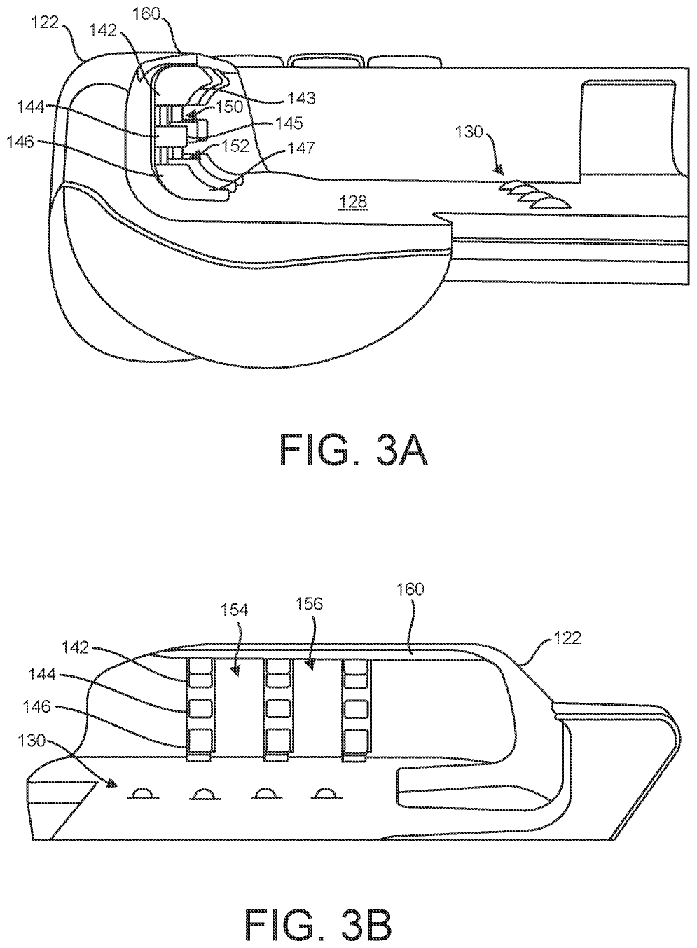

The structure of side tabs 140 is shown in more detail in FIGS. 3A and 3B. FIG. 3A is a top view of the side tabs, while FIG. 3B is a view of the side tabs from the central recessed area of the ergonomic grip.

It can be seen in FIGS. 3A and 3B that side tabs 140 include several sets of individual tabs. In this embodiment, there are three sets of three tabs (where each set is vertically oriented in FIGS. 3A and 3B). Each set of tabs includes an upper tab 142, a middle tab 144, and a lower tab 146. Each of these tabs has a slightly different shape.

Middle tabs 144 have simple rectangular shapes, with a flat inward facing surface 145. Surface 145 contacts the console when it is positioned in the central recessed area of the ergonomic grip. Lower tabs 146 are longer than tabs 144 and have a slightly curved inward and upward facing surface 147. Surface 147 contacts the lower corner of the side of the console when it is positioned in the central recessed area. Upper tabs 142 are also longer than tabs 144, and have a slightly curved inward and downward facing surface 143, which contacts the upper corner of the side of the console when it is positioned in the central recessed area.

Together, surfaces 143, 145 and 147 of the multiple tab sets form a generally curved surface for contacting the sides of the console when it is positioned in the central recessed area of the ergonomic grip. When the console is positioned in the central recessed area, the tabs are compressed, or pushed toward the inner surface of the handle. Spaces 150 and 152 between tabs 142, 144 and 146 allow room for the tabs to expand vertically (up and down in the figure) when they are compressed by the console. Spaces 154 and 156 between the three different sets of tabs allow the tabs to expand laterally (left and right in the figure) when compressed by the console when it is positioned in the central recessed area.

As noted above, the ergonomic grip is designed to securely hold different versions of the console that are slightly different sizes. When a smaller version of the console is positioned in the central recessed area, it contacts the side tabs and compresses them to a degree which is sufficient to hold the console securely within the central recessed area of the grip. When a slightly larger version of the console is positioned in the central recessed area, it again contacts the side tabs, but it compresses them to a slightly greater degree due to the slightly larger size of the console.

It can be seen in the figures that the bottom of lower tabs 146 extends toward the row of tabs 130. At the end of lower tab 146 nearest tabs 130, the lower tab is approximately the same height above central back support 128 as tabs 130. Consequently, the back of the console will be positioned at approximately this height the above central bank support 128 (minus some degree of compression that is experienced by the tabs).

It can also be seen in the figures that the upper edge 160 of handgrip 122 extends inward a bit toward the central recessed area. Upper edge 160 is substantially rigid and provides some support for the upper edge of tabs 142 when the console is installed in the central recessed area. This support helps to prevent the console from simply bending or compressing tabs 142 out of the way so that the console could fall out of the central recessed area of the grip.

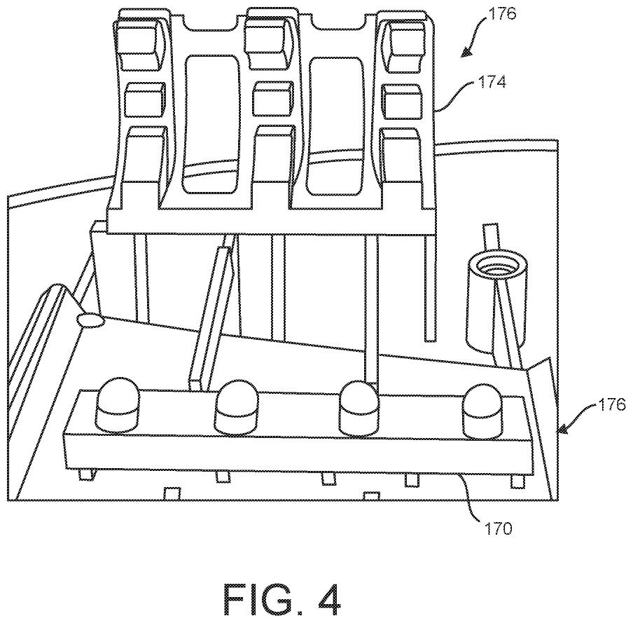

Referring to FIG. 4, a diagram illustrating the structure of assemblies including back tabs 130 and side tabs 140 in accordance with some embodiments is shown. Because back tabs 130 and side tabs 140 are very small, it would be difficult to manufacture them separately and then individually mount them on the rigid structure of the ergonomic grip. Groups of the tabs are therefore manufactured as a unit, and this unit is then installed on the rigid structure of the grip.

The rigid structure of the ergonomic grip which forms central back support 128, grips 120 and 122 and retaining arms 124 and 126 is formed as a two-piece shell. The front half of the shell (the piece which is closest to the central recessed area and the console) has holes in which back tabs 130 and side tabs 140 are positioned. The units which form the groups of tabs are positioned behind the front half of the shell so that the tabs extend through the holes in the shell. The two halves of the shell are then secured to each other, thereby securing the tab assemblies between them with the tabs extending through the holes.

As depicted in FIG. 4, individual back tabs 130 are formed on top of a small block or connecting member 170 to form a back tab unit 172. Similarly, individual side tabs are formed on a substructure (connecting member) 174 to form a side tab unit 176. Back tab unit 172 and side tab unit 176 are shown in the figure positioned on the back half of the ergonomic grip shell in order to clearly illustrate the structure of the tab assemblies. During actual manufacture of the ergonomic grip, it may be easier to assemble the grip by positioning the tab unit on the front half of the grip shell with the tabs extending through the holes, and then fastening the two halves of the shell to each other.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An ergonomic grip for a portable game console comprising:
a central body portion;
a left handgrip connected to a left side of the central body portion and a right handgrip connected to a right side of the central body portion;
a central recessed area formed between the left handgrip and the right handgrip; and
a set of cushioning tabs positioned at one or more interior surfaces of the ergonomic grip, the tabs positioned between the corresponding interior surfaces and the central recessed area;
wherein the ergonomic grip is adapted to securely hold a portable game console in the central recessed area, the cushioning tabs adapted to contact the portable game console and to be compressed between the portable game console and the one or more interior surfaces, wherein friction between the cushioning tabs and the portable game console retains the portable game console in the central recessed area; and
wherein the cushioning tabs are adapted to be compressible to a first, lesser degree to hold a portable game console of a first, smaller size, and compressible to a second, greater degree to hold a portable game console of a second, larger size.

2. The ergonomic grip of claim 1, further comprising a set of side cushioning tabs positioned at one or more interior surfaces of each handgrip, the tabs positioned between the corresponding interior surface and the central recessed area.

3. The ergonomic grip of claim 1, wherein at least a subset of the cushioning tabs comprise a single unit having the subset of cushioning tabs formed integrally with a connecting member.

4. The ergonomic grip of claim 3, wherein at least one of the central body portion, the left handgrip and the right handgrip comprises a shell having a corresponding one of the interior surfaces, the shell having a set of holes through the corresponding one of the interior surfaces, wherein the single unit is positioned with the subset of the cushioning tabs extending through the set of holes, the connecting member of the single unit being secured within the shell.

5. The ergonomic grip of claim 1, wherein the central body portion comprises a back plate which has a substantially planar interior surface facing the central recessed area.

6. The ergonomic grip of claim 5, wherein a left edge of the back plate is connected to a back edge of the left handgrip and a right edge of the back plate is connected to a back edge of the right handgrip.

7. The ergonomic grip of claim 6, wherein each of the left and right handgrips has a corresponding interior surface facing the central recessed area, each handgrip interior surface having a corresponding front edge that wraps around the corresponding side of the central recessed area, extending inward toward the central recessed area.

8. The ergonomic grip of claim 7, further comprising a set of side cushioning tabs positioned at one or more interior surfaces of each handgrip, the tabs positioned between the corresponding interior surface and the central recessed area, the set of side cushioning tabs including one or more front tabs adjacent to the front edges of the handgrip interior surfaces, wherein the front tabs are positioned between the front edges of the handgrip interior surfaces and the central recessed area and are adapted to contact a front edge of a portable game console positioned in the central recessed area.

9. The ergonomic grip of claim 8, the set of side cushioning tabs including one or more back side tabs adjacent to the back edges of the handgrip interior surfaces, wherein the back side tabs are positioned between the back edges of the handgrip interior surfaces and the central recessed area and are adapted to contact a back edge of a portable game console positioned in the central recessed area.

10. The ergonomic grip of claim 5, further comprising a set of back tabs located on the interior surface of the back plate, the set of back tabs adapted to contact a portable game console positioned in the central recessed area and to maintain a space between the portable game console and the interior surface of the back plate.

11. The ergonomic grip of claim 1, further comprising one or more retaining arms connected to the central body portion and extending downward from the central body portion, the retaining arms having corresponding interior surfaces that face the central recessed area.

12. The ergonomic grip of claim 1, further comprising the portable game console, wherein the portable game console is positioned in the central recessed area.

13. A method comprising:
providing a shell of an ergonomic grip, the shell having two or more pieces, wherein the shell has a central body portion, a left handgrip connected to a left side of the central body portion and a right handgrip connected to a right side of the central body portion, the shell having one or more interior surfaces which upon assembly of the shell face a central recessed area of the ergonomic grip, the shell having one or more sets of holes through at least one of the interior surfaces;
providing one or more tab units, each of the tab units having cushioning tabs extending from a connecting member;
positioning each tab unit so that the corresponding cushioning tabs extend through a corresponding set of holes in at least one interior surface of the shell; and
securing the pieces of the shell together to form the ergonomic grip and thereby securing each tab unit in position.

14. The method of claim 13, wherein the tabs are positioned at interior surfaces of the left handgrip and right handgrip.

15. The method of claim 14, further comprising positioning a portable game console in the central recessed area of the ergonomic grip, wherein the portable game console is secured in the central recessed area by contact between left and right edges of the portable game console and the tabs positioned at interior surfaces of the left handgrip and right handgrip.

16. A method comprising:
providing an ergonomic grip, the ergonomic grip having a central body portion, a left handgrip and a right handgrip connected to a right side of the central body portion, a central recessed area formed between the left handgrip and the right handgrip and a set of cushioning tabs positioned at one or more interior surfaces of the ergonomic grip, the tabs positioned between the corresponding interior surfaces and the central recessed area; and
positioning a first portable game console in the central recessed area, wherein the first portable game console compresses the cushioning tabs and wherein friction between the cushioning tabs and the first portable game console retains the first portable game console in the central recessed area.

17. The method of claim 16, removing the first portable game console from the central recessed area of the ergonomic grip and positioning a second portable game console in the central recessed area, the second portable game console being larger in at least one dimension than the first portable game console, wherein the second portable game console compresses the cushioning tabs to a greater degree than the first portable game console and wherein friction between the cushioning tabs and the second portable game console retains the second portable game console in the central recessed area.

18. The method of claim 16, removing the first portable game console from the central recessed area of the ergonomic grip and positioning a second portable game console in the central recessed area, the second portable game console being smaller in at least one dimension than the first portable game console, wherein the second portable game console compresses the cushioning tabs to a lesser degree than the first portable game console and wherein friction between the cushioning tabs and the second portable game console retains the second portable game console in the central recessed area.
